(19) United States
(12) Patent Application Publication
(10) Pub. No.: US 2008/0041210 A1
(43) Pub. Date: Feb. 21, 2008

(54) Circular saw machine

(76) Inventor: Meng-Fu Tseng, Daya Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/504,700

(22) Filed: Aug. 16, 2006

(51) Int. Cl. B23D 45/06

(52) U.S. Cl. 83/473; 83/477.2

(57) ABSTRACT

A circular saw machine consists of a bed, a platform on top of the bed, a board secured in the bed, a swinging support, and a blade; the board has concentric curved slot and curved bar-shaped protrusion; the swinging support has a shaft portion, a curved groove, and a toothed bottom portion, and is joined to the board with the shaft portion being passed through the curved slot, and the curved bar-shaped protrusion fitted in the curved groove; a block with a groove is secured on the swinging support; a sliding block is fitted on the groove; a sleeve is secured on the sliding block, and a shaft is passed through the sleeve and joined to the blade; the blade sticks out through a slot of the platform; a hand-operated worm engages the toothed portion; the saw blade can be adjusted in angle leftwards and rightwards by turning the worm.

### BACKGROUND OF THE INVENTION

1. Field of the Invention

The present invention relates to a circular saw machine, more particularly one, which consists of a secured basic board, a sector-shaped swinging support fitted on secured basic board, a saw blade supported on the swinging support, and a worm engaged with a toothed bottom portion of the swinging support; the saw blade can be adjusted either leftwards or rightwards to a sloping direction.

2. Brief Description of the Prior Art

Circular saw machines are indispensable tools for professional carpenters and people who DIY at home. Circular saw machines can be divided into upright-blade type and sloping-blade one. Upright-blade type circular saw machines can't be adjusted in angle of their saw blades while the saw blades of sloping-type circular saw machines can be adjusted in their angle for meeting various needs, e.g. cutting wooden materials for building and indoor decorating into desired shape.

Referring to FIG. 7, a currently existing circular saw consists of a bed 81, a rotatable bench 82, and a saw blade mechanism 83. The bed 81 has material propping pieces 815 on an upper side while the rotatable bench 82 has an upper supporting member 821 thereon, which has rails 822 thereon. An up and down moving pneumatic cylinder 823 and a material pressing shade 824 are fitted on the upper supporting member 821. The saw blade mechanism 83 consists of a motor (M), and a round saw blade 836.

The bed 81 has an opening on an upper side thereof, a groove 811 encompassing the upper opening, steel beads 812 held in the groove 811, and fixing pneumatic cylinders 813 on its edge. The rotatable bench 82 has a slot 825 thereon for the round saw blade 836 to pass through, and it is fitted over the opening of the bed 81 and supported on the steel beads 812 so as to be capable of being angularly adjusted. The fixing pneumatic cylinders 813 have moving rod parts 814, which can stick out and press the rotatable bench 82 so as to prevent the rotatable bench 82 from turning. Furthermore, the rotatable bench 82 has hanging brackets 826 fitted on a lower side thereof, and the saw blade mechanism 83 is fitted to the hanging brackets 826. The saw blade mechanism 83 has a lower locating member 831, which has rails 832 thereon, and which is secured to the lower side of the rotatable bench 82. The saw blade mechanism 83 has a bit guiding shade 837, which has a gap 8371, and locking pieces 8370 thereon, and is connected to a bit exit pipe 838. The bit guiding shade 837 is secured to the hanging brackets 826 of the rotating bench 82 by means of the locking pieces 8370. A sliding seat 834 is fitted on the rails 832 of the lower locating member 831 so as to be capable of sliding, and a tubular shaft support 8340 is coupled to the sliding seat 834, and a rotating shaft 835 is passed through the tubular shaft support 8340. The round saw blade 836 is joined to one end of the rotating shaft 835, and received in the bit guiding shade 837. The motor (M) is fitted on a lower end of the sliding seat 834, and a moving rod part of an up and down moving pneumatic cylinder 833 is also joined to the lower end of the sliding seat 834; thus, the saw blade 836 can be moved up and down together with the sliding seat 834, the tubular shaft support 8340, the motor (M), and the rotating shaft 835 by means of up and down moving pneumatic cylinder 833. A cylinder body of the up and down moving pneumatic cylinder 833 is secured on the lower locating member 831. A belt (L) is connected to both the motor (M) and the other end of the rotating shaft 835.

Therefore, the saw blade mechanism 83 can be angularly displaced so as to adjust the direction of the saw blade 836 by means of turning the rotating bench 82, eliminating the operator's need to move the large and heavy work piece positioned on the bed 81 and saving strength and time. However, the rotating shaft 835 will always be on the horizontal plane, and the saw blade 836 can't be moved to or adjusted in a sloping position. Consequently, the saw machine has a relatively limited use.

Referring to FIGS. 8 and 9, another kind of currently existing circular saw 10 consists of a base 11, a table 12 on top of the base 11, and a circular saw blade 13 fitted on the table 12 for cutting planks. The base 11 has a curved guide slot 113 on a front side thereof. The saw blade 13 is fitted on a supporting member 14, and a moving rod 19 is passed through and securely joined to the supporting member 14 for the saw blade 13. The moving rod 19 sticks out through the curved guide slot 113 of the base 11, and an adjustment guide wheel is connected to an outer end of the moving rod 19 for adjusting the height of the supporting member 14. And, a transmission guide wheel 16 is pivoted on a lateral side 112 of the base 11, and a transmission shaft 17 is joined to the transmission guide wheel 16, and engaged with a transmission toothed member 18 securely joined to the supporting member 14; thus, the supporting member 14 and the saw blade 13 can be adjusted to a sloping position by means of turning the transmission guide wheel 16. The above saw structure has a disadvantage: adjusting motion of the saw blade 13 is limited owing to existence of the motor and other transmission elements of the saw, and in turn the saw blade 13 can only be angularly displaced towards single direction (leftward or rightward directions). Consequently, such a saw isn't convenient to use.

### SUMMARY OF THE INVENTION

It is a main object of the invention to provide an improvement on a circular saw machine to overcome the above-mentioned problems. The circular saw machine of the present invention consists of a bed, a platform on top of the bed, a basic board secured in the bed, a swinging support, and a saw blade. The basic board has concentric curved slot and curved bar-shaped protrusion thereon. The swinging support has a shaft portion, a curved groove, and a toothed bottom portion, and is joined to the basic board with the shaft portion being passed through the curved slot, and the curved bar-shaped protrusion fitted in the curved groove. A block with a groove is secured on a lateral side of the swinging support while a sliding block is fitted on the groove so as to be capable of sliding. A sleeve is secured on the sliding block, and a shaft is passed through the sleeve. Transmission is connected to the shaft for transmitting motion of a motor to the shaft and the saw blade. The saw blade is joined to the shaft, and sticks out through a slot of the platform. And, a hand-operated worm is engaged with the toothed portion of the swinging support. Therefore, the saw blade can be adjusted leftwards and rightwards to a sloping position by means of turning the worm.

### BRIEF DESCRIPTION OF THE DRAWINGS

The present invention will be better understood by referring to the accompanying drawings, wherein:

FIG. 1 is an exploded perspective view of the present invention,

FIG. 2 is a sectional view of the present invention,

FIG. 3 is a view taken when the present invention is in motion (1),

FIG. 4 is a view taken when the present invention is in motion (2),

FIG. 5 is a view taken when the present invention is in motion (3),

FIG. 6 is a view of the present invention, taken when the blade is being adjusted in height,

FIG. 7 is an exploded perspective view of the first prior art,

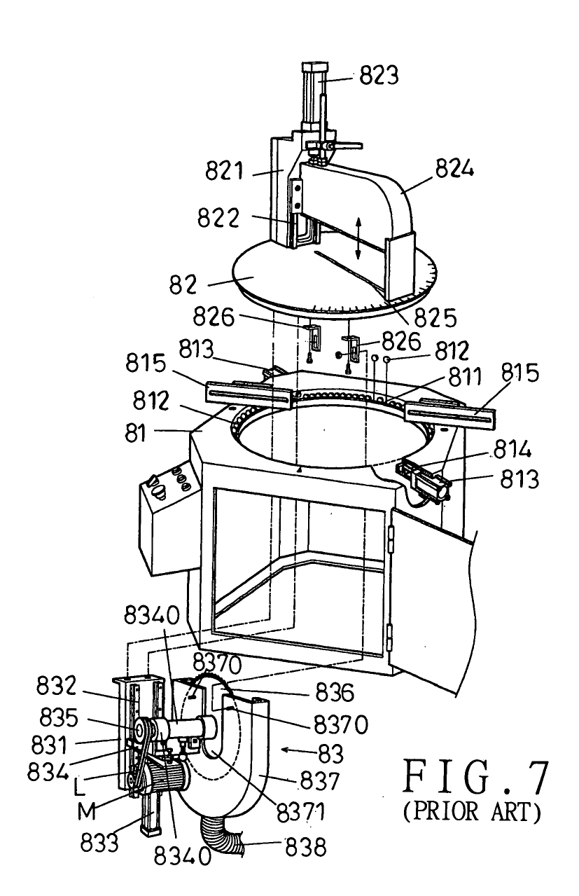

FIG. 8 is a view taken when the second prior art is in motion (1), and

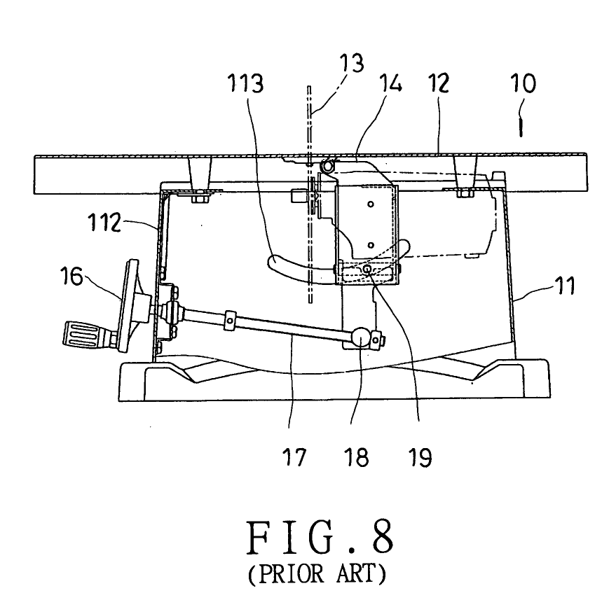

FIG. 9 is a view taken when the second prior art is in motion (2).

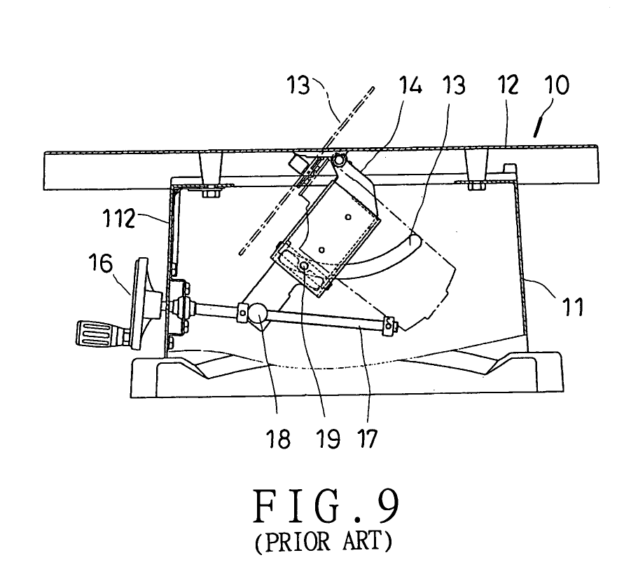

### DETAILED DESCRIPTION OF THE PREFERRED EMBODIMENTS

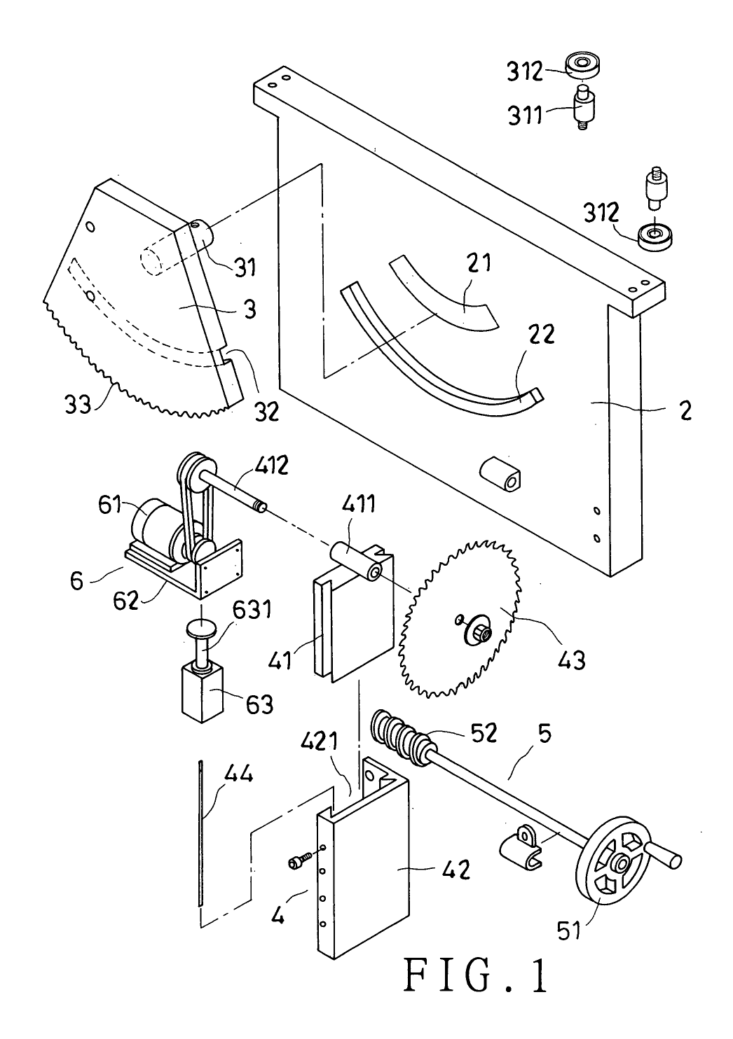

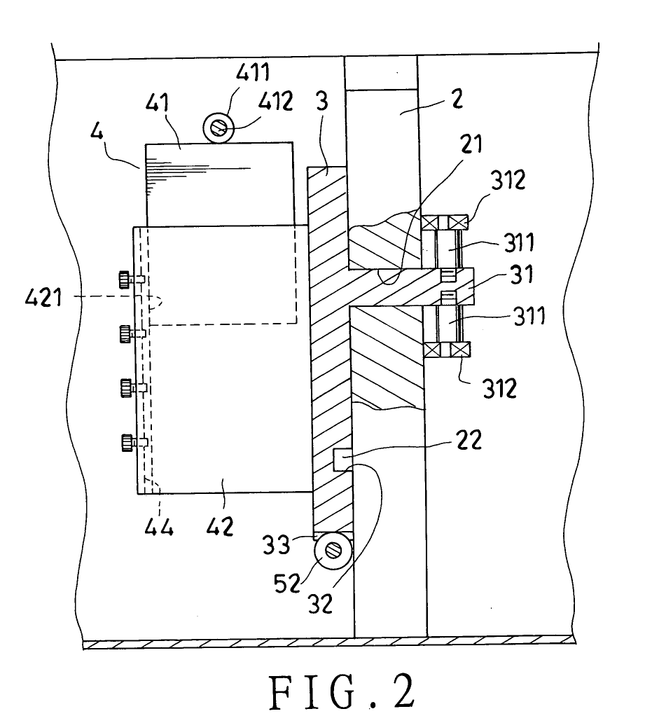

Referring to FIGS. 1 and 2, a preferred embodiment of a circular saw machine of the present invention consists of a bed 1, a basic board 2, a swinging support 3, a sliding assembly 4, a saw blade 43, an operating assembly 5, and an up and down moving mechanism 6. The bed 1 has a working platform 7 positioned on top thereof, which has an slot 71 thereon. And, the saw blade 43 sticks out through the slot 71 of the working platform 7.

The basic board 2 is secured in the bed 1, and it has concentric curved slot 21 and curved bar-shaped protrusion 22 thereon.

The swinging support 3 is sector-shaped, and it has a shaft portion 31 sticking sideways, a curved fitting groove 32 thereon, and toothed portion 33 on a bottom. The swinging support 3 is joined to the basic board 2 with the shaft portion 31 being passed through the curved slot 21, and with the curved bar-shaped protrusion 22 being fitted in the curved fitting groove 32. Off-center insertion rods 312 are securely inserted in upper and lower sides of the shaft portion 31 of the swinging support 2, and bearings 311 are connected to respective ones of the off-center insertion rods 312 so as to touch the lateral side of the basic board 2.

The sliding assembly 4 consists of a sliding block 41, and a fixed block 42. The fixed block 42 has a groove 421 thereon, and the sliding block 41 has a sleeve 411 secured thereon. The fixed block 42 is secured on a lateral side of the swinging support 3 while the sliding block 41 is fitted on the groove 421 of the fixed block 42 so as to be capable of sliding up and down. A central shaft 412 is passed through the sleeve 411 of the sliding block 41, and the saw blade 43 is joined to the central shaft 412 at a center thereof.

The operating assembly 5 consists of a hand-operated wheel 51, and a worm 52 passed through and supported on the bed 1, and securely joined to the hand-operated wheel 51 and engaged with the toothed portion 33 of the swinging support 3. Therefore, the worm 52 will cause angular displacement of the swinging support 3 when rotating.

The up and down moving mechanism 6 consists of a motor 61, a bearing member 62, and a moving cylinder 63. The bearing member 62 is securely joined to the sliding block 41, and the motor 61 is positioned on the bearing member 62 such that motion of the motor 61 will be passed on to the central shaft 412 passed through the sleeve 411 and connected to the saw blade 43. The moving cylinder 63 is securely joined to the fixed block 42 with an output rod 631 thereof propping the bearing member 62. Therefore, the motor 61, the sliding block 41, and the saw blade 43 can be moved up and down together by means of controlling the output rod 631 of the moving cylinder 63. Furthermore, adjustment pieces 44 can be secured on the grooves 421 of the fixed block 42 for adjusting the tightness between the sliding block 41 and the fixed block 42.

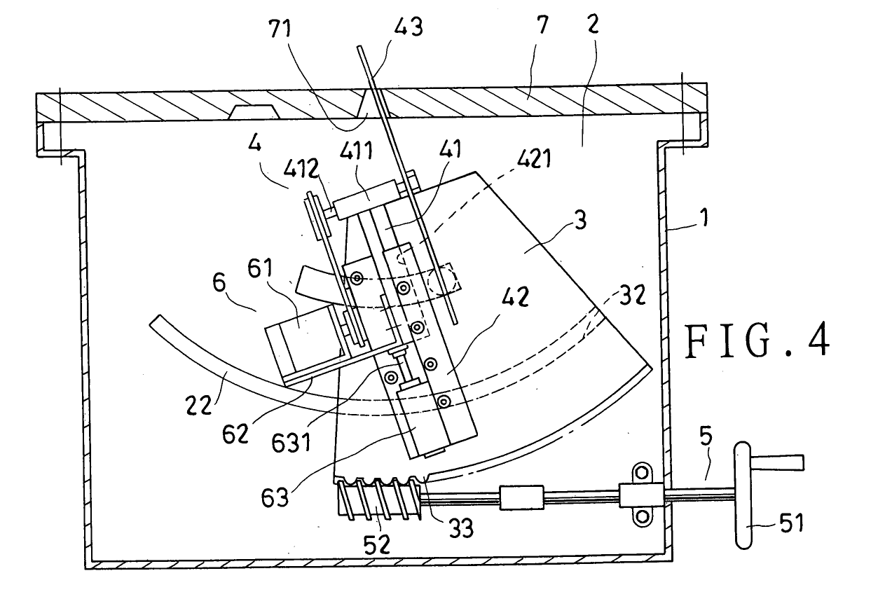

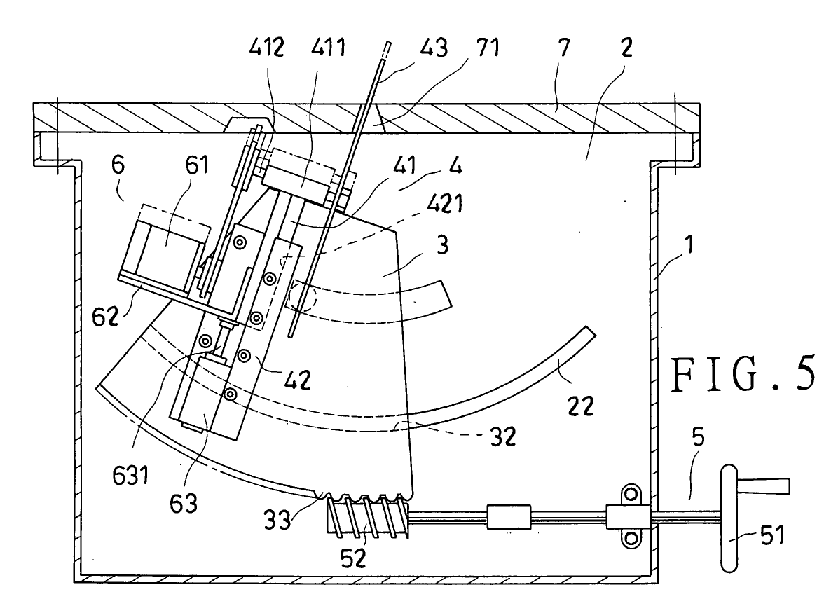

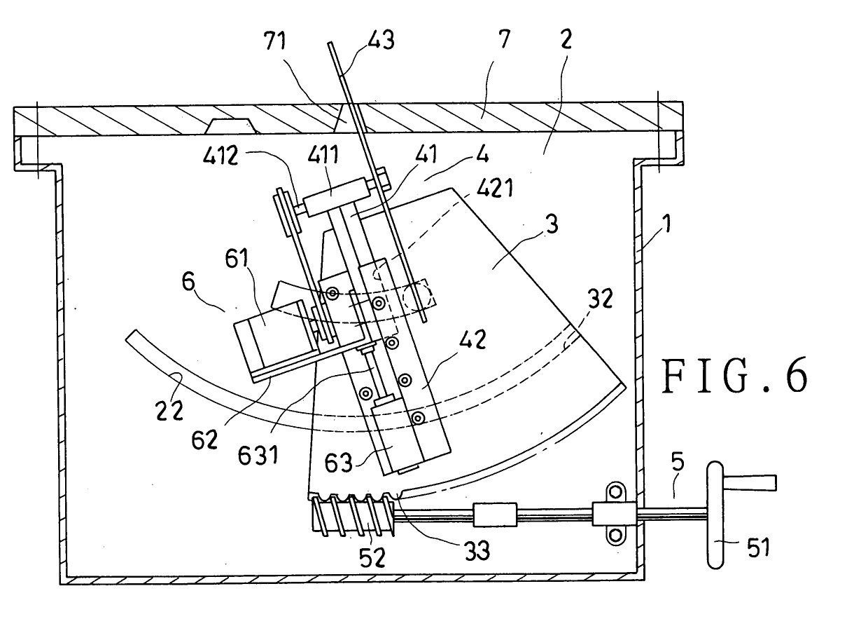

Referring to FIGS. 1 to 6, in assembly, the basic board 2 is secured in the bed 1, and the swinging support 2 is fitted on the basic board 2 with the shaft portion 31 being passed through the curved slot 21, and with the curved bar-shaped protrusion 22 being fitted in the curved fitting groove 32. And, the off-center insertion rods 312 are securely inserted in upper and lower sides of the shaft portion 31 of the swinging support 2, and bearings 311 are connected to respective ones of the off-center insertion rods 312 to touch the lateral side of the basic board 2. Next, the operating assembly 5 is fitted to the bed 1 with the worm 52 being engaged with the toothed portion 33 of the swinging support 3. The fixed block 42 of the sliding assembly 4 is secured on a lateral side of the swinging support 3, and the sliding block 41 is fitted on the groove 421 of the fixed block 42. The central shaft 411 is passed through the sleeve 411 secured on the sliding block 41, and the saw blade 43 is positioned around and securely joined to the central shaft 411. And, transmission (not numbered) is connected to the motor 61 and the central shaft 412 for transmitting motion of the motor 61 to the central shaft 412. The bearing member 62 is positioned under the motor 61 and secured on a lateral side of the sliding block 41. And, the moving cylinder 63 is positioned under the bearing member 62 so as to prop the same.

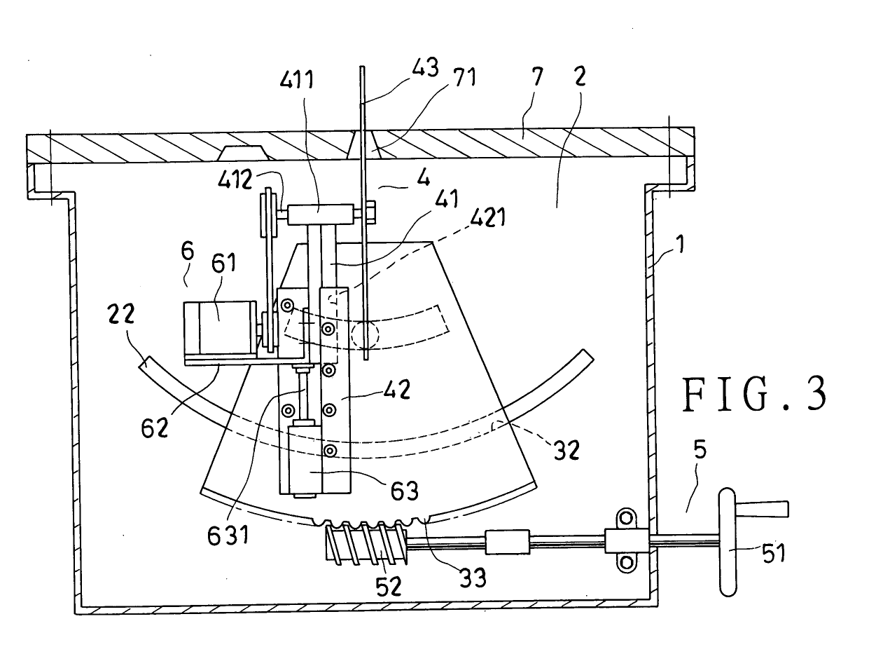

Therefore, the user is allowed to adjust the direction of the saw blade 43 to a sloping one either leftwards or rightwards by means of turning the hand-operated wheel 51; when the hand-operated wheel 51 is turned, the worm 52 will make the swinging support 3 swing with the shaft portion 31 and the curved fitting groove 32 thereof moving in a curved path along the curved slot 21 and the curved bar-shaped protrusion 22 of the basic board 2 respectively, and in turn the sliding assembly 4 and the up and down moving mechanism 6 swing with the swinging support 3, and angle of the saw blade 43 is changed. Referring to FIGS. 3 to 6, in angular adjustment, the saw blade 43 will pivot virtually on an imaginary line lengthways extending along a middle of an uppermost portion of the slot 71 of the working platform 7; in other words, the swinging support 3, and the saw blade 43 will change angle as if they are swinging with the above-mentioned imaginary line as the pivot. Consequently, the slot 71 of the working platform 7 doesn't have to be formed with a very wide uppermost portion.

In addition, the user is allowed to change the height of the saw blade 43 by means of the moving cylinder 63; when the moving cylinder 63 is actuated, the output rod 631 will move so as to cause the bearing member 62 and the sliding block 41 to change height.

From the above description, it can be seen that the circular saw of the present invention has the following advantages:

1. The saw blade of the circular saw machine can be adjusted either leftwards or rightwards to a sloping direction because the circular saw is equipped with the swinging support, the basic board, and the worm, and the swinging support together with the sliding assembly and the saw blade will move in a curved path along the curved slot and the curved bar-shaped protrusion of the basic board when the worm is turned.

2. In angular adjustment, the saw blade of the circular saw machine will pivot virtually on an imaginary line lengthways extending along a middle of an uppermost portion of the slot of the working platform owing to the swinging support, the basic board, and the worm; when the worm is turned, the swinging support, the sliding assembly, and the saw blade will change angle as if they are swinging with the above-mentioned imaginary line as the pivot. Therefore, adjustment of the angle of the saw blade will be relatively smooth and precise.

3. For the same reason, the saw blade of the circular saw machine will pivot virtually on the imaginary line in its angular adjustment even when the moving cylinder is used to change the height of the saw blade.

4. The slot of the working platform doesn't have to be formed with a very wide uppermost portion because the saw blade will pivot virtually on the above-mentioned imaginary line when it is angularly adjusted.

What is claimed is:

1. A circular saw machine, comprising
(a) a bed, the bed having a working platform fitted on a top thereof; the working platform having a slot thereon;
(b) a basic board secured in the bed, the basic board having concentric curved slot and curved bar-shaped protrusion thereon;
(c) a swinging support, the swinging support having a shaft portion, and a curved fitting groove thereon; the swinging support having a toothed portion on a bottom thereof, the swinging support being joined to the basic board with the shaft portion being passed through the curved slot, and with the curved bar-shaped protrusion being fitted in the curved fitting groove; the shaft portion of the swinging support having off-center insertion rods securely inserted in upper and lower sides thereof; the off-center insertion rods each having a bearing connected thereto;
(d) a sliding assembly, the sliding assembly consisting of:
a fixed block secured on a lateral side of the swinging support, the fixed block having a groove thereon; and
a sliding block, the sliding block having a sleeve secured thereon; the sliding block being fitted on the groove of the fixed block so as to be capable of sliding on the fixed block; the sleeve having a central shaft passed through it;
(e) a saw blade fitted around and joined to the central shaft at a center thereof; the saw blade sticking out through the slot of the working platform;
(f) an operating assembly, the operating assembly consisting of:
a hand-operated wheel, and
a worm securely joined to the hand-operated wheel and engaged with the toothed portion of the swinging support; and
(g) an up and down moving mechanism for adjusting height of the sliding block and the saw blade;
whereby the saw blade together with the sliding assembly will be adjusted leftwards and rightwards to a sloping position when the hand-operated wheel is turned to change orientation of the swinging support.

2. The circular saw machine as recited in claim 1, wherein the swinging support is sector-shaped.

3. The circular saw machine as recited in claim 1, wherein the up and down moving mechanism consists of:
a bearing member securely joined to the sliding block of the sliding assembly,
a motor positioned on the bearing member, the motor being connected to the central shaft for causing rotation of the saw blade; and
a moving cylinder securely joined to the fixed block of the sliding assembly with an output rod thereof propping the bearing member.
